(19) United States
(12) Patent Application Publication
(10) Pub. No.: US 2011/0300271 A1
(43) Pub. Date: Dec. 8, 2011

(54) NOVELTY SEALED FOOD PRODUCTS AND METHOD OF MANUFACTURE OF SAME

(75) Inventor: Roberto Capodieci, Scottsdale, AZ (US)

(73) Assignee: Creative Resonance, Inc., Scottsdale, AZ (US)

(21) Appl. No.: 13/154,995

(22) Filed: Jun. 7, 2011

Related U.S. Application Data
(60) Provisional application No. 61/352,051, filed on Jun. 7, 2010.

(51) Int. Cl. A23L 1/025; A21C 9/04

(52) U.S. Cl. 426/238; 99/450.4

(57) ABSTRACT

An apparatus and method for manufacturing a novelty sealed food product having a complex shape. The apparatus including an anvil plate and an ultrasonic horn that seals a filling within a pair of food substrates with an ultrasonic vibration and without a sealing additive, such as a carbohydrate or a hydrocolloid.

### CROSS REFERENCE TO RELATED APPLICATION

This application claims the benefit of U.S. Provisional Application No. 61/352,051, filed on 7 Jun. 2010.

### BACKGROUND OF THE INVENTION

1. Field of the Invention

This invention relates generally to a novelty sealed food product and a method and apparatus for manufacturing the novelty sealed food product. Specifically, this invention relates to a novelty sealed food product that is formed by sealing an upper food substrate and a lower food substrate with an ultrasonic horn, where the upper and lower food substrate may be, but not limited to, a white bread, a multi-grain bread, a whole-wheat bread, a sponge cake, a tortilla, a pita, a pide, a piadina, a naan, and a type of meat.

2. Description of the Related Art

Convenience food products have been favorite items of the food industry for many years and it does not appear there is an end in sight for this constantly expanding segment. Seeking to profit from this constantly expanding segment, the food industry has made numerous attempts to create convenience items, such as fresh and frozen filled sandwiches, which may be readily prepared by the consumer by inserting them in a variety of household heating devices such as ovens, toasters, panini presses, etc.

Since these convenience foods are prepared in ovens, toasters, panini presses, it is desirable that the foods be designed to prevent leakage of a filling during preparation regardless of the required product placement, vertical or horizontal, in the above mentioned heating devices. Further, since these convenience foods are often consumed “on-the-run,” it is also desirable that the foods be designed to prevent leakage of the filling during consumption.

These convenience food are often marketed to specific types of consumers, such as children and commuters, or to celebrate holiday seasons, such as Easter, Christmas and Valentine's Day. Accordingly, it would be ideal to create sealed food items with complex shapes and attractive sealing patterns to attract consumers or celebrate holidays.

Finally, it is also desirable that other types of sealed food items can be made from a larger variety of baked products as well as other basic product such as meats.

In light of the above, known methods for preparing a sealed or leakless sandwich come in essentially in three major categories: (1) application of an edible functional medium such as carbohydrates/hydrocolloids; (2) application of the above functional medium with the enhancement of heat, such as that achievable by the use of a dielectric field; and (3) simple mechanical crimping/compression.

In the first prior art category, a pair of slices of bread are coated, on one surface, with a thin layer of a carbohydrate or a hydrocolloid. Subsequently, a filling is applied to the coated surface of one bread slice and finally the coated sides of the two slices are placed in a face to face contact to complete the sandwich. This method may further include partially cooking or browning of the sandwich prior to freezing and packaging. The heating step helps the sealing/gluing action of the carbohydrate or the hydrocolloid on the filling.

Edible hydrocolloids such as pregelatinized starches (potato and corn starch), unmodified starch, carrageenin, variety of gums and/or gelatin are often used in a dry form or a hydrated slurry form. With the dry form, the dry hydrocolloid is hydrated by the moisture of the bread and/or moisture in the sandwich filling. In the hydrated slurry form, the hydrated slurry is applied like liquid glue to the surfaces to be treated. In either form, the hydrocolloid functions to retain the filling in place. Sealing per se, trimming and/or shaping of the sandwich is generally not a part of this method.

In the second category, a sealed sandwich is created by spreading a functional medium, such as an edible carbohydrate, along the perimeter of two slices of bread. The functional medium is then activated by a dielectric field to form a seal. Carbohydrates, such as starches, sugar mixtures and gums, when acted upon by heat in the presence of moisture become pasty and capable of forming a physical bond. This approach was later refined to obviate side effects of earlier technology, the dielectric field is imparted to the product in a plurality of interrupted instances rather than applied in single prolonged step.

In the third category, a sealed sandwich is created using a cold press method, a mechanical action where the seal is created at an ambient temperature by compressing a pair of slices of bread along a desired perimeter with a suitable crimping device. This method creates the seal without heating and/or applying a functional ingredient to the slices of bread. Moreover, the crimping device can be profiled with an inner crimping shoulder as well as an outer cutting edge. With such a crimping device, the product can be sealed, trimmed of its crust and possibly shaped into a desirable silhouette in one single plunging motion. Alternatively, the system might consist of two concentric devices independently actuated, an inner one for crimping/sealing, and the outer one for trimming. Another variation of the cold pressing method utilizes crimping/trimming rollers rather than plunging devices. In essence, a pre-sealed sandwich advances continuously through a first set of crimping rollers which press side edges forming two longitudinal seals. Subsequently, the partially sealed sandwich is rotated by 90 degrees and fed through a second crimping station identical to the previous one, where the last two edge seals are applied.

All the above described embodiments carry a significant number of limitations. Each requires a wide area for forming a seal. Further, product release of these methods is at best questionable, the formed products have a tendency to stick to the crimping surfaces. As a result, some form of mechanical or pneumatic extractors are often required, adding complexity to the system and extending the process cycle times, resulting in a reduced production capacity. The erratic product release also prevents the sealing and shaping of a product along a complex silhouette. Finally, the choice of filling ingredients may be limited by the inherent integrity of the seal.

The previously known methods which rely on a functional medium to form a seal, not only require an additional ingredient, equipment and an application step but also require a relatively long time before the seal integrity is achieved. Delaying subsequent processing steps such as, baking and frying.

The previously known methods which rely on dielectric heating, require cycle times in excess of 25-30 seconds, which substantially increases manufacturing times and costs. Moreover, these methods require complex design features to shield the filling from the heating effect of the dielectric fields, often with marginal success. Also, these methods have significant safety hazards, such as arcing (especially when high moisture is present) and physical injuries due to manual stripping of the product (due to the lack of product release).

The previously known methods which rely on cold pressing alone, while simpler in nature, require white bread because it very dense and moist. The mere presence of bran or other grains, such as in wheat or multi-grain breads, is sufficient to reduce the integrity of the seal, or even prevent the accomplishment of a seal altogether.

### SUMMARY OF THE INVENTION

In light of all the above, the present invention relates to a method and an apparatus for producing a sealed food item that obviates the deficiencies and limitations of the prior art.

The apparatus for manufacturing the sealed food product of this invention includes an anvil plate which couples with an ultrasonic horn to create a cavity for forming the sealed food item of this invention. In a preferred embodiment, the anvil plate includes a ridge and a recessed cavity for receiving a foodstuff. The ridge can be designed to have any simple or complex shape including, but not limited to, a circle-shape, a square-shape, and animal-shapes. Further, the ridge may comprise a narrow or wide dimension with a textured or smooth surface. While the recessed cavity is preferably a shape which corresponds to the shape of the ridge.

Positioned over the anvil plate is the ultrasonic horn. In a preferred embodiment, the ultrasonic horn is a part of an ultrasonic stack which is powered to operate at a frequency ranging from 5 to 60 KHz. In a preferred embodiment, the ultrasonic horn is a spool type ultrasonic horn with a flat face with a similar or complementary shape to the anvil plate. In an alternative embodiment, the ultrasonic horn includes a face with a concave surface, a convex surface, a textured surface and/or an imprint.

The apparatus of this invention preferably further includes an actuator, such as a pneumatic actuator, which moves the ultrasonic horn towards the anvil plate so that the ridge will cooperate with the ultrasonic horn face to squeeze the foodstuff positioned in-between to form the sealed food item of this invention.

A method of manufacturing the sealed food product according to one embodiment of this invention involves placing a lower food substrate on the anvil plate. The lower food substrate may be any type of food capable of forming a lower “shell” of the sealed food item including, but not limited to, a white bread, a multi-grain bread, a whole-wheat bread, a sponge cake, a tortilla, a pita, a pide, a piadina, a naan, and a type of meat.

With the lower food substrate positioned on the anvil plate, the method further includes applying at least one filling component to an upper surface of the lower food substrate. The filling component can be selected from a wide variety of food items including, but not limited to, peanut butter, jelly, chocolate, fruit, meat, cheese, eggs, cream, custard and any combination of two or more items.

With the filling component in place, an upper food substrate is positioned over the lower food substrate and the filling component. The upper food substrate is preferably the same type of food as the lower food substrate however the upper food may be another type of food that is capable of being sealed to the lower food substrate.

With the food items in place on the anvil plate, the ultrasonic horn is lowered to crimp the upper food substrate and the lower food substrate along a perimeter to contain the filling. Energy is injected into the ultrasonic horn causing it to vibrate, preferably at an ultrasonic frequency, to form the seal about the perimeter. After the seal is formed, the energy to the ultrasonic horn is reduced and/or discontinued and the ultrasonic horn is raised from the anvil plate to expose the sealed food product. In an alternative embodiment of this invention, the ultrasonic horn is energized a second time to release the sealed food product from the ultrasonic horn and preferably onto a conveyor belt.

An object of the present invention is to provide a sealed food item based on a variety of baked products other than white bread, such as a multi grain, whole wheat breads, sponge cakes and a variety of ethnic flat breads (tortillas, pita, pide, piadina, naan, etc.). Another object of this invention is provide a sealed food item with two pieces of meat forming the upper and lower substrate.

An object of this invention is to provide the sealed food item with an unlimited variety of characteristics including sweet and savory flavors, smooth and chunky texture, etc.

An additional object of this invention is a sealed food item of more complex silhouettes, not limited to the traditional, square, rectangular or circular shapes. An embodiment of this invention provides a sealed food item with two or more concentric seals. Another embodiment of this invention provides a sealed food item with a multiple repetitive pattern such as a quilting pattern.

A further object is to provide a sealed food item with a seal width reduced virtually to a thin line. An embodiment of this invention accomplishes this object through a narrow-width ridge.

### DESCRIPTION OF THE DRAWINGS

FIG. 1 shows a perspective view of an apparatus for forming a novelty sealed food product according to an embodiment of this invention;

FIG. 2 shows a perspective view of the apparatus of FIG. 1 at a sealing stage of forming the novelty sealed food product according to an embodiment of this invention;

FIG. 3 shows a circular sealed food product according to an embodiment of this invention;

FIG. 4 shows a cross-section view of the circular sealed food product of FIG. 3;

FIG. 5 shows a sealed food product with a doughnut shape according to one embodiment of this invention;

FIG. 6 shows another sealed food product with a doughnut shape and a center product according to another embodiment of this invention;

FIG. 7 shows a top view representation of an anvil plate for forming a ringed shaped sealed food product according to an embodiment of this invention;

FIG. 8 shows a perspective view of an ultrasonic horn for forming a pocket-type sealed food product according to an embodiment of the invention;

FIG. 9a shows a cross-section view of the ultrasonic horn of FIG. 8;

FIG. 9b shows a top view of the ultrasonic horn of FIG. 8;

FIG. 10 shows a cross-section view of the ultrasonic horn of FIG. 8 positioned over a upper food substrate, a filing component and a lower food substrate;

FIG. 11 shows a plurality of sealed food products formed with the ultrasonic horn of FIG. 8;

FIG. 12a shows a cross-section view of an ultrasonic horn for forming an open-pocket-type sealed food product according to an embodiment of the invention;

FIG. 12b shows a bottom view of the ultrasonic horn of FIG. 12a;

FIG. 13a shows a top view of a quilt pattern sealed food product according to an embodiment of the invention;

FIG. 13b shows a cross sectional view of the quilt pattern sealed food product of FIG. 13a taken along line A-A of FIG. 13a;

FIG. 14 shows a top view of a sealed food product according to an embodiment of the invention;

FIG. 15 shows a bottom view of an ultrasonic horn with a teddy bear trim pattern according to an embodiment of the invention; and

FIG. 16 shows a sealed meat medallion according to an embodiment of this invention.

### DESCRIPTION OF PREFERRED EMBODIMENTS

The following description includes various embodiments of the subject invention. The subject invention is not limited to the embodiments covered by the description since it will become clear how those skilled in the art can extrapolate numerous possible embodiments of the invention.

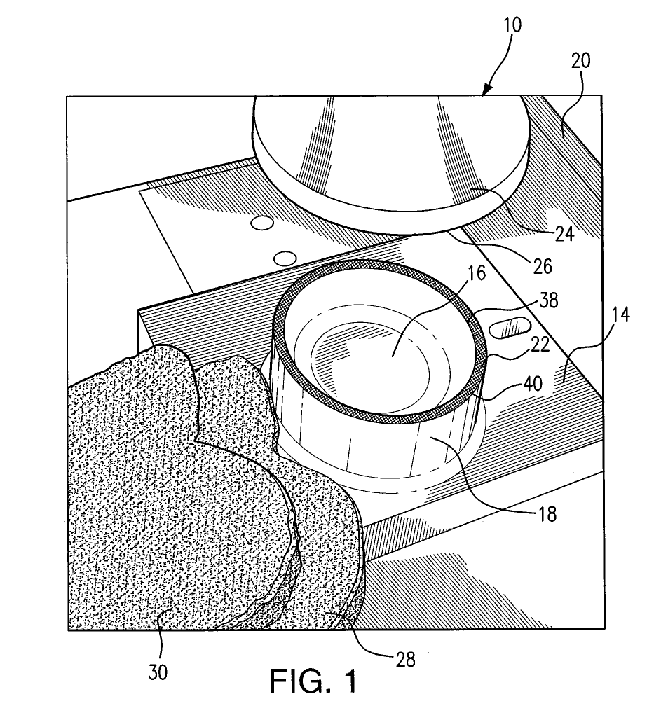

FIG. 1 shows a perspective view of apparatus 10 for forming a novelty sealed food product 12 according to one embodiment of this invention. The apparatus 10 of this invention includes a support surface comprising an anvil plate 14 fastened to a work plate 20. The anvil plate 14 includes a forming cavity 16 defined on an edge by a ridge 18. In the embodiment of FIG. 1, the ridge 18 is generally circular in shape although the ridge 18 may be any other simple or complex shape including, but not limited to, a square shape, a triangle shape, a heart shape, or an animal-shape. In this embodiment, the ridge 18 further includes a knurled edge 22, however, this invention does not require the knurled edge 22 and may include alternative edge profiles including a flat edge. In an alternative embodiment, the ridge 18 may further include a cutting element, not shown, to trim the novelty sealed food product 12.

In the embodiment of FIG. 1, an ultrasonic horn 24 is positioned over the at least a portion of the anvil plate 14 and engageable with the forming cavity 16 and the ridge 18 to form the novelty sealed food product 12 of this invention. The ultrasonic horn 24 is preferably part of an ultrasonic stack (not shown) that includes a converter and a suitable booster, which is connected to a power supply through a radio frequency cable. In a preferred embodiment, the ultrasonic horn 24 is a spool type ultrasonic horn, however, the ultrasonic horn 24 may be any type of ultrasonic horn including, but not limited to, a cylindrical-type, a bar-type or a composite. In the embodiment of FIG. 1, the ultrasonic horn 24 includes an ultrasonic horn face 26, in this case a flat circular face, that corresponds to the circular shape of the ridge 26. Alternatively, the ultrasonic horn face 26 may comprise any shape and preferably a shape that corresponds to the forming cavity 16 and the ridge 18 of the anvil plate 14. In another embodiment, the ultrasonic horn face 26 may include a cavity. In still another embodiment, the ultrasonic horn face 26 may include a texture or a relief that may be impressed into the novelty sealed food product 12 of this invention.

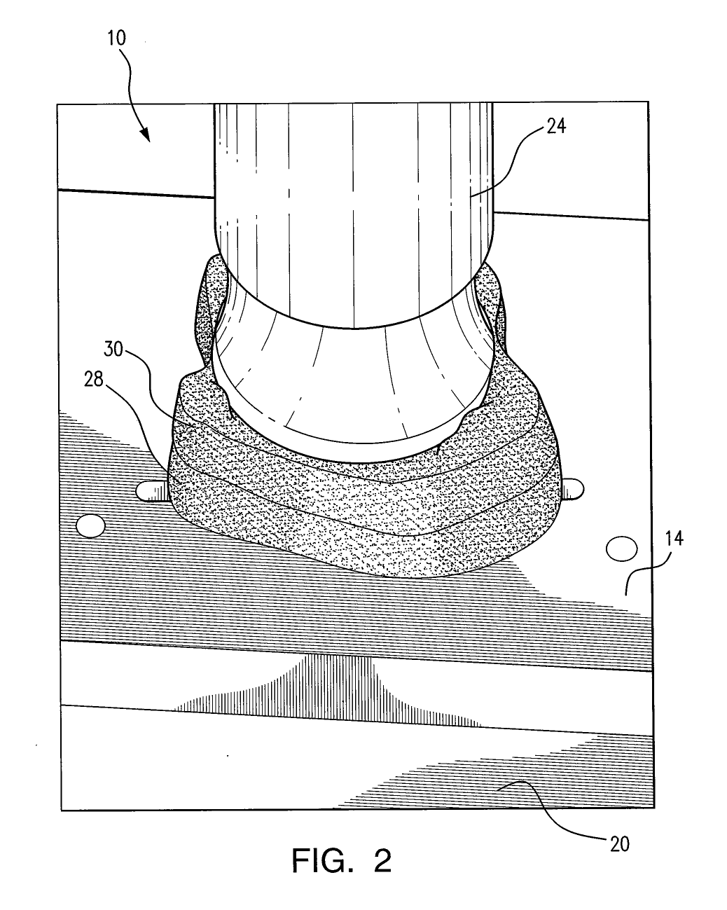

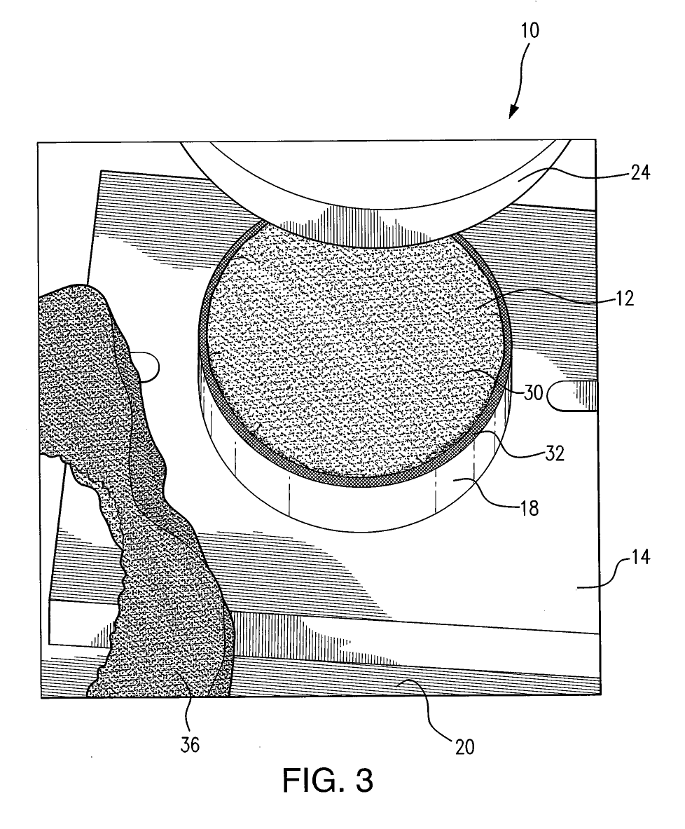

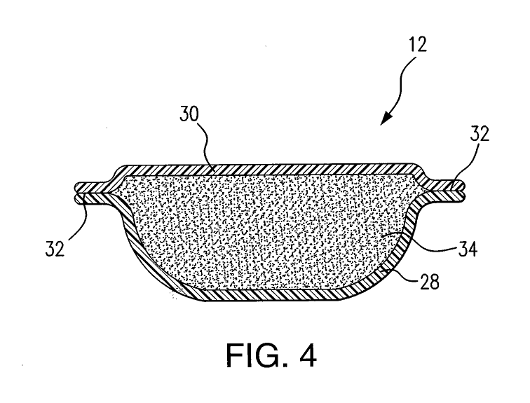

In operation, the ultrasonic stack is operated in a vertical plane by an actuator (not shown). In a preferred embodiment, the actuator is a pneumatic actuator, however, the actuator can be any type of actuator capable of moving the ultrasonic stack in a vertical direction to bring the ultrasonic horn face 26 in cooperation with the forming cavity 16 and the ridge 18. As shown in FIGS. 2 and 3, a portion of the ultrasonic horn face 26 and the ridge 18 squeeze a lower food substrate 28 and an upper food substrate 30 to form a sealed edge 32 of the novelty sealed food product 12. In the embodiment of FIGS. 2 and 3, the lower food substrate 28 and the upper food substrate 30 are each slices of white bread. However, this invention is not limited to white bread, but may any type of food capable of forming a “shell” of the sealed food product 12 including, but not limited to, a multi-grain bread, a whole-wheat bread, a sponge cake, a tortilla, a pita, a pide, a piadina, a naan, and a type of meat.

The ultrasonic stack is designed to operate at frequencies between 5 and 60 KHz, preferably, given the size of a typical finished product, at 20 KHz. The gain of the components is preferably selected such as to provide an amplitude range between 10 to 100 microns, with the desirable operating amplitude to be established experimentally based upon the product design and type of baked or non-baked food product comprising each of the lower food substrate 28 and the upper food substrate 30.

A method of manufacturing the sealed food product of this invention includes the following steps. Positioning the lower food substrate 28 on top of the forming cavity 16 and the ridge 18. Applying at least one filling component 34 to an upper surface of the lower food substrate 28. The filling component 34 can be selected from a wide variety of food items including, but not limited to, peanut butter, jelly, chocolate, fruit, meat, cheese, eggs, cream, custard and any combination of two or more items. With the filling component 34 in place, the method includes positioning the upper food substrate 30 over the lower food substrate 28 and the filling component 34. With each of the food items in place on the anvil plate 14, the ultrasonic horn 24 is actuated to move downward to crimp the upper food substrate 30 and the lower food substrate 28 to form a crimped edge along a perimeter to contain the filling component 34. Energy is then injected into the ultrasonic horn 24 form the sealed edge 32 about the perimeter. After the seal edge 32 is formed, the energy to the ultrasonic horn 24 is reduced or discontinued and the ultrasonic horn 24 is raised from the anvil plate 14 to expose the sealed food product 12. In an embodiment of this invention, the sealed food product remains in contact with the ultrasonic horn 24 and the ultrasonic horn 24 is energized a second time to release the sealed food product 12 from the ultrasonic horn 24.

Since a pocket created by the filling component 34 interposed between the upper food substrate 30 and the lower food substrate 28 will occupy and conform to the forming cavity 16, the energy imparted by the ultrasonic horn face 26 on the sealed food product 12 will be concentrated on an annular region of the sealed food product 12 corresponding to the ridge 18 which in effect behaves as an “energy director,” as the term is known and understood to those having ordinary skill in the art. As a consequence, the sealed edge 32 is formed on the finished sealed food product 12, preferably without disturbing a region of the product that incorporates the filling component 34. According to a preferred embodiment of this invention, heat is applied in a form of vibrational energy to moist carbohydrates of the food substrates 28, 30 as they are being crimped along a pattern determined by the ridge 18 and the ultrasonic horn face 26.

According to an embodiment of this invention, the time required to create the described seal edge 32 is a short time frame, typically in a range between 50 to 500 msec and preferably for approximately 250 msec. Such cycle times are well below the 25-30 seconds required by the prior art method involving dielectric fields, by a factor of 100. An overall cycle time, including descending and raising the ultrasonic stack, preferably takes approximately 500 msec, which corresponds to a frequency or rate of two 2 cycles per second. Thus, this invention includes an inherent production capacity advantage over prior known methods. Moreover, given the geometry of the system and the short weld times of this invention and since energy directed to the seal area alone, this invention should be considered a cold-press method.

This invention also provides production capacity improvement over previously known methods. As described above, the sealed edge 32 is formed by superimposing a rapidly alternating compressive force, derived from the ultrasonic vibration of the horn, to a static compression force, imparted by the actuator. The static compression force is typically ⅕th to 1/10th of the forces required by previously known cold pressing methods. Combining the low compression forces with short cycle time, allow for an extremely light and streamlined process equipment that is inherently capable of a high capacity.

In an embodiment of this invention, a vibration amplitude of the ultrasonic stack varies between a maximum value and a minimum value, where the minimum value is greater than zero. By maintaining the vibration amplitude greater than zero for an entire cycle, the sealed food product 12 readily releases from the ultrasonic horn 24 without a mechanical or pneumatic extractor. Moreover, since energy is preferably only injected during the weld time of the cycle, that is when the ultrasonic horn face 26 is compressing the sealed food product 12 against the anvil plate 14, this invention is extremely energy efficient.

By properly profiling an amplitude of the ultrasonic vibration during the process cycle, separation of the finished product from its edge trim can be implemented. In an embodiment of this invention, after the weld time, an edge trim 36 can be manually removed and discarded. In a preferred embodiment, separation of the edge trim 36 from the sealed food product 12 can be accomplished automatically with means known to those having ordinary skill in the art.

As shown in FIG. 1, a width from an inner profile 38 of the ridge 18 to an outer profile 40 of the ridge 18 is relatively wide, however as shown in FIG. 3, the sealed edge 32 of the sealed food product 12 formed is a thin line. The seal quality is excellent both in terms of strength and integrity. In an alternative embodiment, the sealed edge 32 may be formed with multiple indentations or with a wider surface. These embodiments can be created by suitably designing the ridge 18.

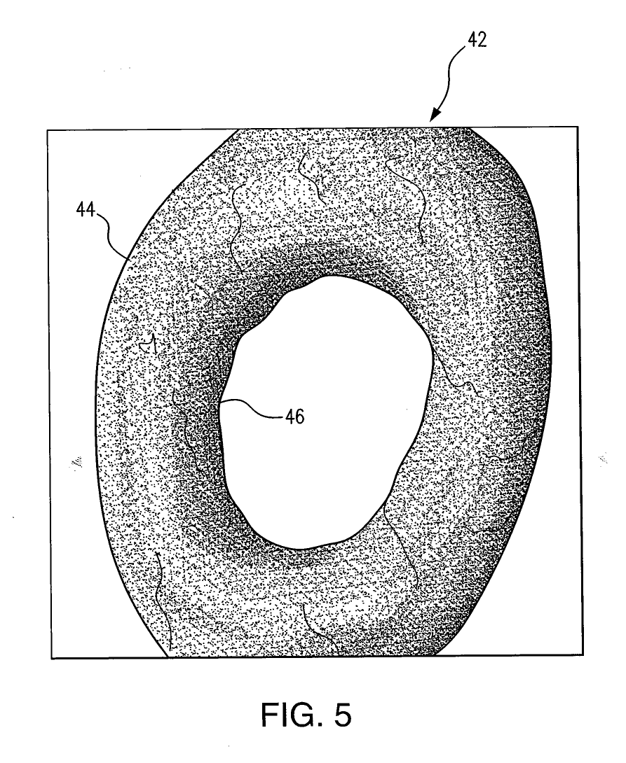

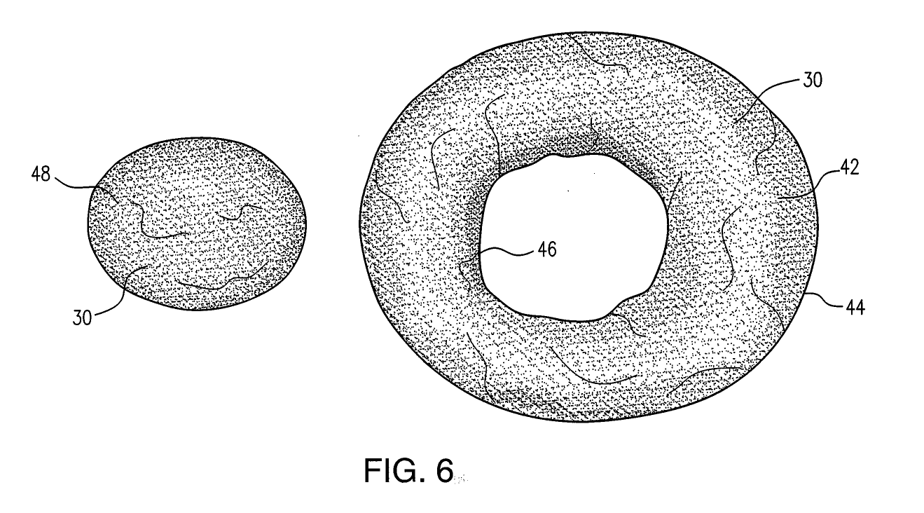

FIGS. 5 and 6 show an alternative embodiment of this invention comprising a plurality of concentric seals forming a sealed doughnut 42 with an outer doughnut edge 44 and an inner doughnut edge 46. The embodiment of FIG. 6 further includes a filled center 48. In an embodiment of this invention, the sealed doughnut 42 and the filled center 48 may be filled with a mixture of scrambled eggs, cheese and ham, creating a breakfast savory alternative to the traditional doughnuts. In a preferred embodiment, the sealed doughnut 42 utilizes whole wheat bread as the upper and lower food substrate 30, 28. However, the sealed doughnut 42 is not limited to whole wheat bread but may any type of food capable of forming a “shell” of the sealed doughnut 42 including, but not limited to, a multi-grain bread, a white bread, a sponge cake, a tortilla, a pita, a pide, a piadina, a naan, and a type of meat.

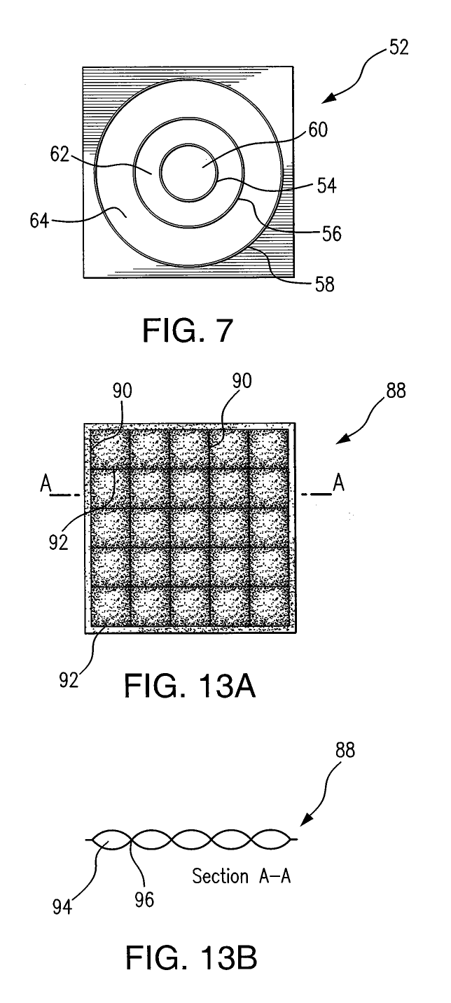

FIG. 7 shows an apparatus with multiple concentric seals for forming a multiple ring sealed doughnut 50. This apparatus is a doughnut anvil plate 52 with an inner ridge 54, a middle ridge 56 and an outer ridge 58. Positioned inside the inner ridge 54 is a inner forming cavity 60. Positioned between the inner ridge 54 and the middle ridge 56 is a middle forming cavity 62. Positioned between the middle ridge 56 and the outer ridge 58 is an outer forming cavity 64. The doughnut anvil plate 52 can be used with the ultrasonic stack described above to define three distinct “filled areas,” each one containing a same filling or a different filling. In an alternative embodiment, each of the inner ridge 54, middle ridge 56 and outer ridge 58 include a knife edge allowing the three distinct “filled areas” to be separated after forming.

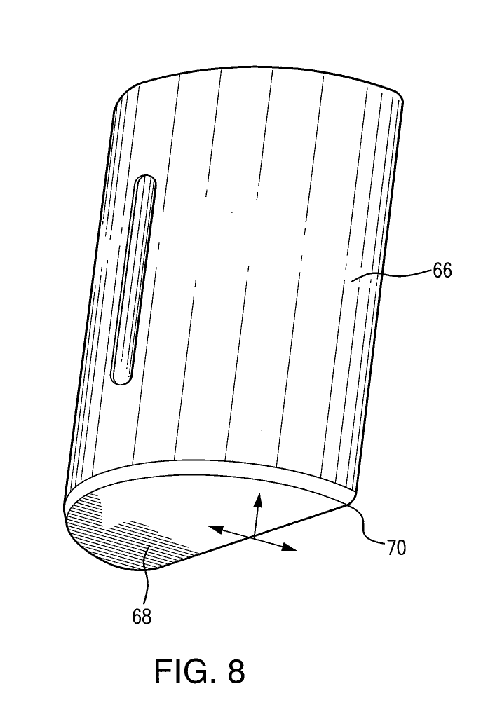

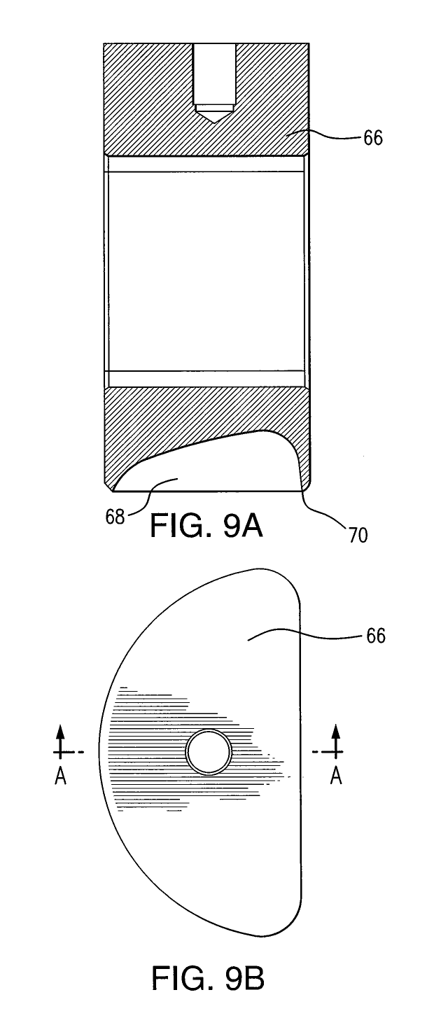

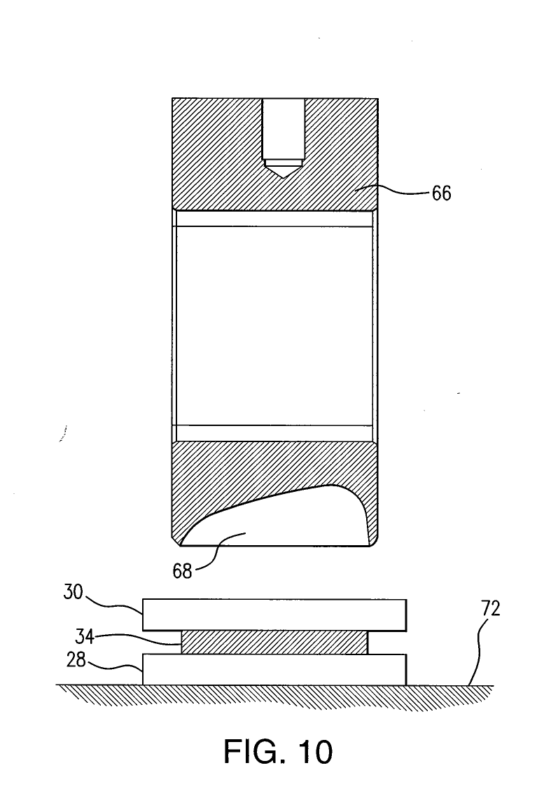

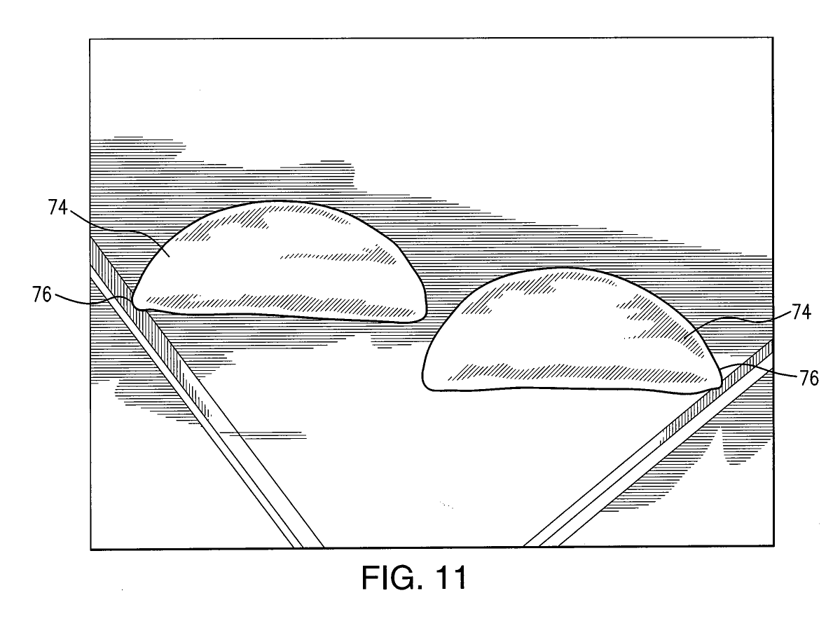

FIGS. 8-10 show an alternative embodiment of an ultrasonic horn 66. The alternative ultrasonic horn 66 includes a ultrasonic horn forming cavity 68 and a sealing and trimming edge 70. In this embodiment, the alternative ultrasonic horn 66 may be used with a support surface comprising a flat working plate 72, as shown in FIG. 10. Alternatively, the alternative ultrasonic horn may be used with an anvil plate including recessed cavity and matching sealing ridge. FIG. 11 shows a sealed food product 74 formed with the alternative ultrasonic horn 66 with a continuous thin line seal 76. Alternatively, a more complex aesthetically pleasing seal can be formed with a suitably designed horn with a crimping/sealing edge.

Several features are associated with the embodiment of FIGS. 8-10. First, it is unnecessary that the sealing and trimming edge 70 be sharp. On the contrary, the sealing and trimming edge 70 may be sufficiently rounded to prevent cutting through the product rather than sealing and trimming as it is desirable. Likewise, if a thin line seal is to be achieved, the angles off the vertical of the cavity walls are preferably designed depending on the product characteristics, in order to prevent cutting through the product. These restriction generally don't apply if a wider (wider than a thin line) seal is desired.

The alternative ultrasonic horn 66 simplifies the forming process of this invention by negating the need to remove a formed food product from the forming cavity 16 in the anvil plate 14. In essence, at the end of the weld/seal time the amplitude of the vibration is brought to a minimum suitable value, the alternative ultrasonic horn 66 will typically carry the sealed product in the forming cavity 68 on its way up, while its complementary edge trim will remain on the working plate 72. Subsequently, a sudden increase to a maximum suitable amplitude is imparted to the alternative ultrasonic horn 66 releasing the sealed food product 74 from the cavity 68. In an embodiment of this invention, the apparatus further includes a retractable bull nose arrangement, not shown, and a conveyor belt, not shown, which operate to catch and transport the sealed food product to a next station, such as a packaging station.

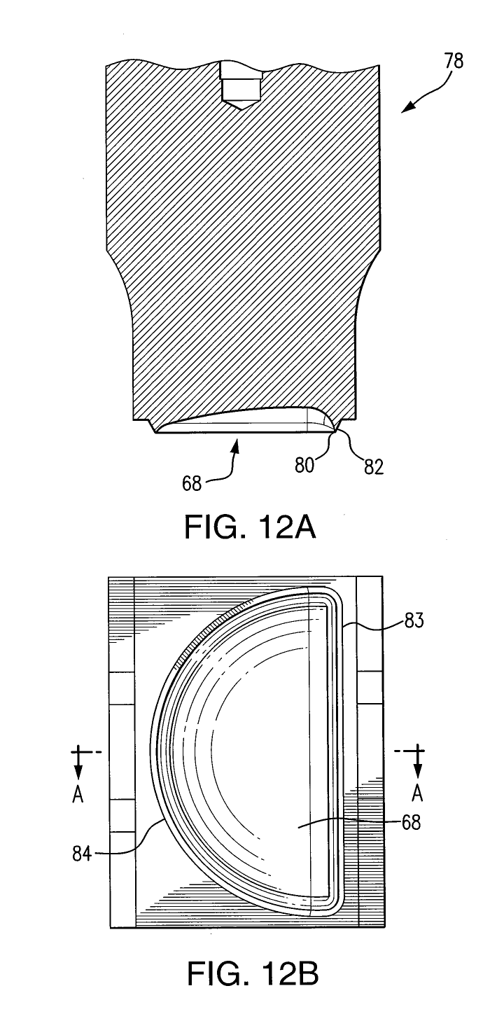

FIGS. 12a and 12b show a pocket forming ultrasonic horn 78 according to an alternative embodiment of this invention. The pocket forming ultrasonic horn 78 includes a relatively vertical inner wall 80 and a sharp edge portion 82 on a straight ridge 83 while the other side includes a curved ridge 84, similar to the ridge described above. The pocket forming ultrasonic horn 78 creates a pocket sealed food product 86 that is partially sealed on a curved portion and open on a straight portion. Allowing, the pocket sealed food product 86 to be filled manually at a later time.

FIGS. 13a and 13b show a quilted pattern sealed food product 88 according to an alternative embodiment of this invention. The quilted pattern sealed food product 88 includes a plurality of orthogonal seal lines 90, 92 formed in at least one or the upper food substrate and the lower food substrate. In this embodiment, the plurality of orthogonal seal lines 90, 92 are formed perpendicular to each other, however, this invention is not limited to perpendicular seal lines and may have any orientation to each other and/or may comprise curved seal lines. In FIG. 13a, the plurality of orthogonal seal lines 90, 92 are formed into the upper food substrate and/or the lower food substrate by suitably designing the ultrasonic horn face and/or the ridges in the anvil plate. As shown in the cross sectional view of FIG. 13b, this embodiment includes a plurality of filled “pillows” 94 separated by seal lines 96. Placement of filling in the pillows 94 can be realized with multiple means known by those having ordinary skill in the art.

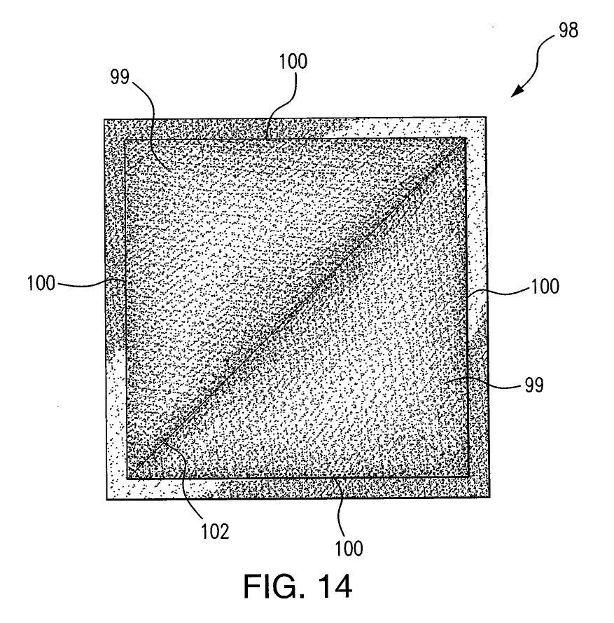

FIG. 14 shows a divided square shaped sealed food product 98 according to an alternative embodiment of this invention. The divided square shaped sealed food product 98 includes a plurality of sealed edges 100 around a perimeter of the product 98 and a cut-open hypotenuse 102 bisecting the product 98. In this embodiment, the ultrasonic horn face and/or the ridges on the anvil plate suitably designed to prepare two triangular products 99. The divided square sealed food product 98 provides an open sandwich that exposes the filling to a consumer allowing the consumer to visually distinguish a variety of sandwiches.

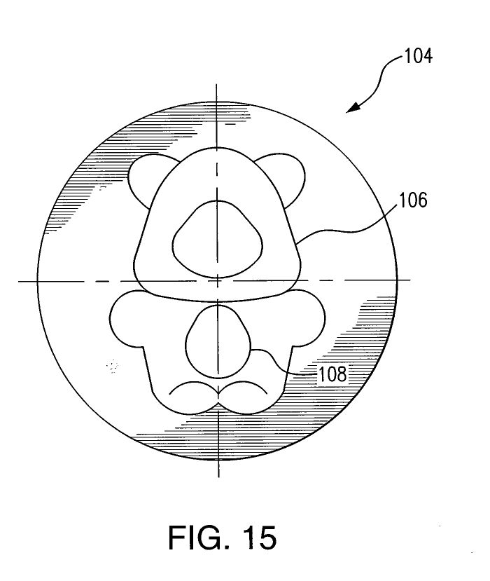

FIG. 15 shows a character shaped ultrasonic horn face 104 with an outer edge 106 that forms a silhouette desirable for products aimed at children. Interior lines 108 of the character shaped ultrasonic horn face 104 impart a suitable surface definition and details to the finished sealed food product's outer surface. In this embodiment, the character shaped ultrasonic horn face 104 comprises a teddy bear shape, however, the character shaped ultrasonic horn face may comprise any type of character including a dog, a turtle, a cowboy and a super hero. In an alternative embodiment, the ultrasonic horn face may comprise a pattern suitable for seasonal products including, but not limited to, a heart, a clover, a bell and a pumpkin.

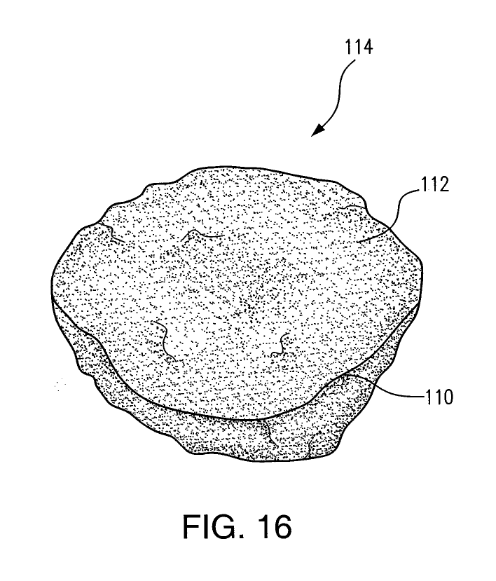

FIG. 16 shows another embodiment of this invention. In this embodiment, a circular seal 110 formed between two slices of raw meat 112 that retain a suitable filling, thereby creating a stuffed meat medallion 114. The circular seal 110 occurs as a consequence of coagulation of meat proteins as energy is injected along the circular seal 110 perimeter. The stuffed meat medallion 114 can be immediately frozen or partially cooked and then frozen prior to entering a distribution pipeline.

As far as the architecture of an apparatus suitable to accomplish the variety of product described, it would be beneficial to refer to the following processes, one describing a single station process and the others a multi station processes.

According to an embodiment of this invention, the single station process includes the following steps that may be performed in sequence, though not necessarily in the following order: (1) placement of the lower food substrate, such as a lower bread portion on the anvil plate; (2) application of one or more of the filling components to the upper surface of the lower bread portion; (3) position the upper substrate, such as an upper bread portion over the lower portion and filling; and (4) lower the ultrasonic horn to crimp the upper and the lower bread portions along a predetermined perimeter to contain the filling component; (5) inject energy through ultrasonic vibration to execute the seal; (6) raise the ultrasonic horn to release the finished sealed product; (7) separate the complementary edge trim; and (8) remove finished sealed product.

According to an embodiment of this invention, the multi-station process (parallel processing) includes the following steps that may be performed in parallel, though not necessarily in the following order: (1) at a first station—placement of the lower food substrate on anvil plate; (2) at a second station comprising at least one and possibly multiple substations—application of one or more of the filling components to the lower food substrate at one or more substations; (3) at a third station—position the upper food substrate; (4) at a fourth station—lower the ultrasonic horn, inject energy, execute seal and disengage horn from the product; (5) at a fifth station—discard the edge trim; and (6) at a sixth station—deliver finished sealed food product.

According to an embodiment of this invention, the multi-station process (parallel processing) with pick and place includes the following steps that may be performed in parallel, though not necessarily in the following order: (1) at a first station—placement of the lower food substrate on the anvil plate; (2) at a second station and/or additional substations—application of one or more filling components to the lower bread portion at one or more stations; (3) at a third station—position the upper food substrate; (4) at a fourth station—lower the ultrasonic horn, inject energy, execute seal, raise horn and release finished sealed product on a take away conveyor; and (5) at a fifth station—discard edge trim.

While in the foregoing specification this invention has been described in relation to certain preferred embodiments thereof, and many details have been set forth for purpose of illustration, it will be apparent to those skilled in the art that the invention is susceptible to additional embodiments and that certain of the details described can be varied considerably without departing from the basic principles of the invention.

I claim:

1. A method of manufacture of a sealed food product comprising the steps of:
placing a lower food substrate on a support surface;
applying at least one filling component to an upper surface of the lower substrate;
positioning an upper food substrate over the lower food substrate and the filling component;
lowering an ultrasonic horn to crimp the upper food substrate and the lower food substrate along a predetermined perimeter to contain the filling component;
energizing the ultrasonic horn to form a seal through ultrasonic vibration;
raising the ultrasonic horn to expose the sealed food product.

2. The method of claim 1 further comprising the step of:
energizing the ultrasonic horn to release the sealed food product from the ultrasonic horn.

3. The method of claim 1 further comprising the step of:
separating at least a portion of a resulting edge trim from the sealed food product.

4. The method of claim 1 further comprising the steps of:
moving the lower food substrate to one or more filling stations; and
applying a second filling component to the lower food substrate.

5. The method of claim 1 wherein the lower substrate and the upper substrate comprise at least one of a bread, a dough, a meat, a tortilla, a pide, a piadina and a naan.

6. The method of claim 1 further comprising the step of:
providing a series of ridges within the ultrasonic horn to result in a sealed food product having a quilted appearance.

7. The method of claim 1 further comprising the step of:
providing a knurled edge around a perimeter of the ultrasonic horn.

8. The method of claim 1 further comprising the step of:
providing at least one stylized edge within the ultrasonic horn to result in a sealed food product having a fanciful, decorative appearance.

9. A method of manufacture of a sealed food product comprising the steps of:
providing a lower bread portion;
applying at least one filling component to the lower bread portion;
positioning an upper bread portion over the lower bread portion and the at least one filling component;
lowering a cavity of an ultrasonic horn over the upper bread portion and the lower bread portion to contain the filling along a perimeter; and
energize the ultrasonic horn to seal the lower bread portion to the upper bread portion and create the sealed food product.

10. The method of claim 9 further comprising the steps of:
raising the ultrasonic horn; and
energize the ultrasonic horn to release the sealed food product from the ultrasonic horn.

11. An apparatus for manufacturing a sealed food product comprising:
a support surface for receiving a lower food substrate;
a filler for providing at least one filling component to the lower food substrate;
a carrier for positioning an upper food substrate over the lower food substrate; and
an ultrasonic horn including a perimeter and a cavity, wherein the perimeter imparts a sealed edge to the lower food substrate and the upper food substrate and the cavity accommodates at least a portion of the lower food substrate, the filling component and the upper food substrate.

12. The apparatus of claim 11, wherein the support surface comprises an anvil plate which further includes a ridge and a forming cavity positioned within the ridge.

13. The apparatus of claim 12, wherein the ridge further includes a knurled edge.

14. The apparatus of claim 12, wherein at least one of the cavity and the forming cavity includes a pattern.

15. The apparatus of claim 12, wherein at least one of the ultrasonic horn and the ridge comprise a complex silhouette.

16. The apparatus of claim 15, wherein the complex silhouette comprises one of a circle, a square, a doughnut-shape, a heart-shape or an animal-shape.

17. The apparatus of claim 11, wherein the cavity of the ultrasonic horn includes a sharp edge portion.
